(19) United States
(12) Patent Application Publication
(10) Pub. No.: US 2025/0016099 A1
(43) Pub. Date: Jan. 9, 2025

(54) COMPLIANCE CONTROL FOR TRAFFIC FLOWS IN A WIRELESS COMMUNICATION SYSTEM

(71) Applicant: Telefonaktiebolaget LM Ericsson (publ), Stockholm (SE)

(72) Inventors: Victor Millnert, Bjärred (SE); Emma Wittenmark, Lund (SE); Christer Östberg, Staffanstorp (SE)

(21) Appl. No.: 18/710,250

(22) PCT Filed: Nov. 18, 2021
(86) PCT No.: PCT/EP2021/082119

§ 371 Date: May 15, 2024

(51) Int. Cl. H04L 47/12; H04L 47/2425; H04L 47/32; H04L 47/6275

(52) U.S. Cl. CPC H04L 47/12; H04L 47/2433; H04L 47/32; H04L 47/6275

(57) ABSTRACT

There is provided mechanisms for handling a traffic flow in a wireless communication system. A method is performed by a controller. The method comprises monitoring a traffic flow on a bearer between an application server and a user equipment in the wireless communication system. The traffic flow is scheduled by a scheduler. The method comprises determining whether or not the traffic flow fulfils a compliance requirement. The compliance requirement pertains to a recommended bitrate is maintained for the traffic flow. The method comprises performing a mitigating action for the traffic flow when the traffic flow fails to fulfil the compliance requirement.

### TECHNICAL FIELD

Embodiments presented herein relate to a method, a controller, a computer program, and a computer program product for handling a traffic flow in a wireless communication system.

### BACKGROUND

Current wireless communication networks are enabled to host high-throughput services, such as streaming services. One reason for this is the use of buffers in strategic places along the applications traffic paths in the wireless communication network. However, this might not be sufficient for wireless communication networks to be able to host low-latency services since the current wireless communication networks might cause jitter and latency-spikes for applications hosted on top of the radio access network part of the wireless communication network.

Such latency spikes and jitter might appear when congestion occurs in the radio access network. Therefore, if it was possible to reduce the congestion by reducing the throughput of the applications sufficiently fast, the latency spikes and jitter might be reduced.

Techniques to address this issue will be disclosed next. Some of the techniques involve the use of congestion marking within the wireless communication network. Some of the techniques involve over-the-top solutions, where congestion is addressed at transmission control protocol (TCP) level. The main focus of the present disclosure is the former, i.e., when the congestion marking is performed from within the wireless communication network, where the actual congestion occurs.

For low-latency, low-loss, scalable throughput (L4S) services, one alternative is to set up a new, dedicated bearer, for the L4S-traffic, and then dynamically (or statically) control the amount of time/frequency resources (i.e., radio resources) allocated to the different bearers. This allows the wireless communication network to differentiate between non-L4S traffic (such as mobile broadband (MBB) traffic) and L4S traffic, allowing the non-L4S traffic to have the typical high-throughput but with jittery traffic characteristics, and the L4S traffic to have low-latency characteristics.

One approach to realize this is to run a virtual system in parallel with the real system. In other words, a virtual queue in the radio access network is set up and it is estimated how long it will take the virtual system to process this virtual queue. By doing so, it is possible to also estimate a virtual delay for processing of the incoming packets. Should this virtual delay be larger than a certain threshold, some of the incoming packets are marked as congested. Packets marked as congested will act as indicators to the application server that the application server should lower the rate by which it sends the packets, thus eventually alleviating the congestion.

To achieve a low latency and resource control, bearers dedicated for L4S traffic flows should have a higher scheduling priority compared to bearers serving MBB traffic flows. In such scenarios, since L4S traffic flows have a higher priority than MBB traffic flows, the system is depending on the assumption that the L4S traffic flows are compliant. By being compliant implies that the L4S traffic flow is reacting to the packets marked as congested as expected, e.g., by lowering their bitrate. That is, that the information source that provides the L4S traffic flows operates according to the congestion markings by lowering the throughput of the L4S traffic flows. However, there might be scenarios where, for some reasons, the information source does not react in the expected manner. This could result in that L4S traffic flows continuing to be non-compliant. The same can occur also for other types of traffic flows than L4S traffic flows.

### SUMMARY

An object of embodiments herein is to address the above issues. In general terms, the above issues are addressed by providing techniques for protecting a wireless communication system against non-compliant traffic flows.

According to a first aspect there is presented a method for handling a traffic flow in a wireless communication system. The method is performed by a controller. The method comprises monitoring a traffic flow on a bearer between an application server and a user equipment in the wireless communication system. The traffic flow is scheduled by a scheduler. The method comprises determining whether or not the traffic flow fulfils a compliance requirement. The compliance requirement pertains to a recommended bitrate is maintained for the traffic flow. The method comprises performing a mitigating action for the traffic flow when the traffic flow fails to fulfil the compliance requirement.

According to a second aspect there is presented a controller for handling a traffic flow in a wireless communication system. The controller comprises processing circuitry. The processing circuitry is configured to cause the controller to monitor a traffic flow on a bearer between an application server and a user equipment in the wireless communication system. The traffic flow is scheduled by a scheduler. The processing circuitry is configured to cause the controller to determine whether or not the traffic flow fulfils a compliance requirement. The compliance requirement pertains to a recommended bitrate is maintained for the traffic flow. The processing circuitry is configured to cause the controller to perform a mitigating action for the traffic flow when the traffic flow fails to fulfil the compliance requirement.

According to a third aspect there is presented a controller for handling a traffic flow in a wireless communication system. The controller comprises a monitor module configured to monitor a traffic flow on a bearer between an application server and a user equipment in the wireless communication system. The traffic flow is scheduled by a scheduler. The controller comprises a determine module configured to determine whether or not the traffic flow fulfils a compliance requirement. The compliance requirement pertains to a recommended bitrate is maintained for the traffic flow. The controller comprises an action module configured to perform a mitigating action for the traffic flow when the traffic flow fails to fulfil the compliance requirement.

According to a fourth aspect there is presented a computer program for handling a traffic flow in a wireless communication system, the computer program comprising computer program code which, when run on a controller, causes the controller to perform a method according to the first aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects protect the wireless communication system from non-compliant traffic flows to overindulge radio resources.

Advantageously, these aspects can be used for making non-compliant traffic flows compliant again.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a wireless communication network according to embodiments;

FIG. 2 is a block diagram of a wireless communication network according to embodiments:

FIG. 3 is a block diagram of a network node according to embodiments:

FIG. 4 is a flowchart of methods according to embodiments;

FIG. 5 is a schematic diagram showing functional units of a controller according to an embodiment:

FIG. 6 is a schematic diagram showing functional modules of a controller according to an embodiment; and

FIG. 7 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

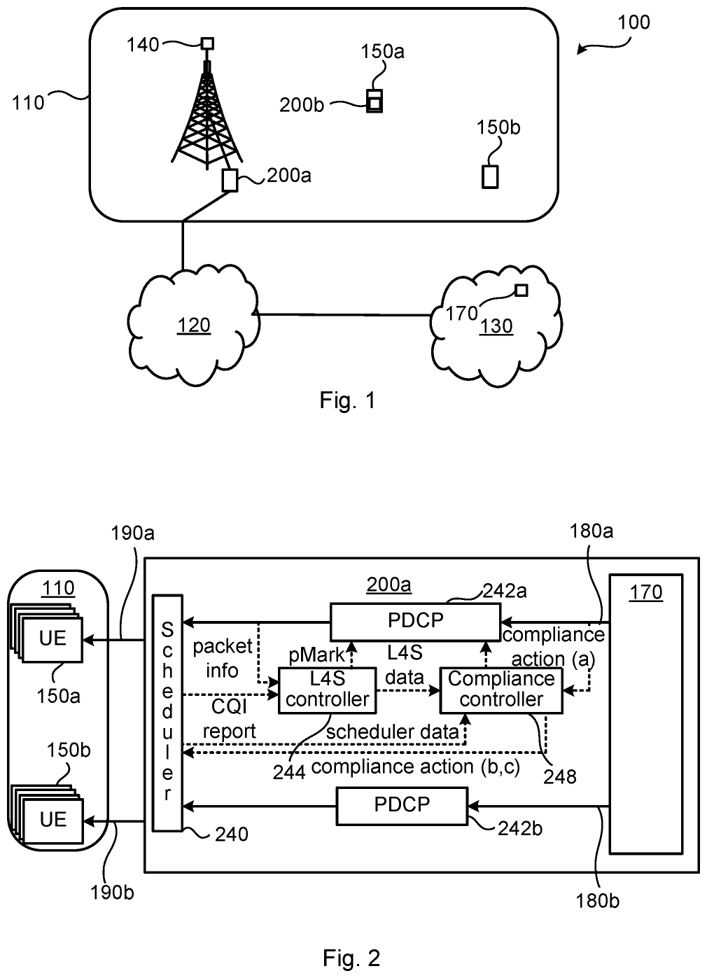

FIG. 1 is a schematic diagram illustrating an example wireless communication system 100 where embodiments presented herein can be applied. The wireless communication system 100 could be a third generation (3G) telecommunications network, a fourth generation (4G) telecommunications network, a fifth generation (5G) telecommunications network, or any evolvement thereof, and support any 3GPP telecommunications standard, where applicable. The wireless communication system 100 could alternatively be a non-cellular and/or a non-3GPP network, such as an IEEE 802.11 communications network, or any other wireless IEEE compliant communications network. The wireless communication system 100 comprises a network node 200 provided in a (radio) access network 110. The network node 200 is configured to, via a transmission and reception point 140, provide network access to user equipment 150a, 150b. The (radio) access network 110 is operatively connected to a core network 120. The core network 120 is in turn operatively connected to a service network 130, such as the Internet. An application server 170 is provided in the service network 130 to represent services available in the service network 130. The user equipment 150a, 150b are thereby enabled to, via the network node 200 and its transmission and reception point 140, access services of, and exchange data with, the service network 130. Examples of network nodes 200 are radio access network nodes, radio base stations, base transceiver stations, Node Bs, evolved Node Bs, gNBs, access points, and integrated access and backhaul nodes. Examples of user equipment 150a, 150b are wireless devices, mobile stations, mobile phones, handsets, wireless local loop phones, smartphones, laptop computers, tablet computers, network equipped sensors, network equipped vehicles, and so-called Internet of Things devices. The herein disclosed embodiments might, however, also be used in the context of virtualized switches, virtualized routers, or any other type of virtualized networks on top of which latency-sensitive applications are hosted.

As noted above, there might be scenarios where, for some reasons, an information source does not react to lower the bitrate of its traffic flows when congestion occurs, and that this could result in that some traffic flows continue to be non-compliant.

In further detail, to illustrate this, assume a wireless communication network where L4S traffic is allocated a radio resource share of 50%, giving the rest of the 50% to MBB traffic. Assume further that this allocation is not hard (i.e., it is not performed through radio-partitioning, or similar), but instead is a soft allocation, controlled at a higher layer where the bitrate of the L4S flows is controlled. Assuming that there is a single user for the L4S traffic in the wireless communication network. 50% of all the radio resources are allowed be allocated for serving this single user.

One technique to ensure this is to observe incoming channel quality reports of the users of the L4S traffic. From these reports, a recommended bitrate can be determined for the L4S traffic. That is, the recommended bitrate is determined as a function of the channel quality reports. This means that, should the L4S traffic have a throughput of this bitrate, it will require 50% of the radio resources. Assuming that the bearer for the L4S traffic has a higher priority compared to the bearer of the MBB traffic, the scheduler will give the L4S traffic as much radio resources as is requested. It is therefore paramount that the L4S traffic flow does not have an incoming bitrate higher than this recommended bitrate for a prolonged amount of time. With reference to the above disclosed virtual system, by means of using a virtual queue, the virtual queue can be built up as soon as the incoming traffic flow exceeds the recommended bitrate (even though a real queue is not built up, since the L4S traffic has a higher priority).

If this virtual queue builds up to sufficiently large levels, packets will be started to be marked as congested. This will then signal to the server of the L4S traffic that it needs to lower its throughput, and thus drive the throughput down towards the recommended bitrate.

While this technique allows to give a higher priority to the L4S traffic (and therefore achieve a low latency for the L4S traffic) this technique becomes sensitive to misuse. That is, the technique depends on the assumption that the L4S servers react to the packets marked as congested. Should there be non-compliant L4S servers, or users (either malicious L4S servers, or users, or simply L4S servers, or users, which are too slow to react to the packets marked as congested, or too greedy), this may lead to the L4S traffic flows stealing more than their share of the radio resources. Needless to say, the issue grows with the number of non-compliant L4S servers, or users.

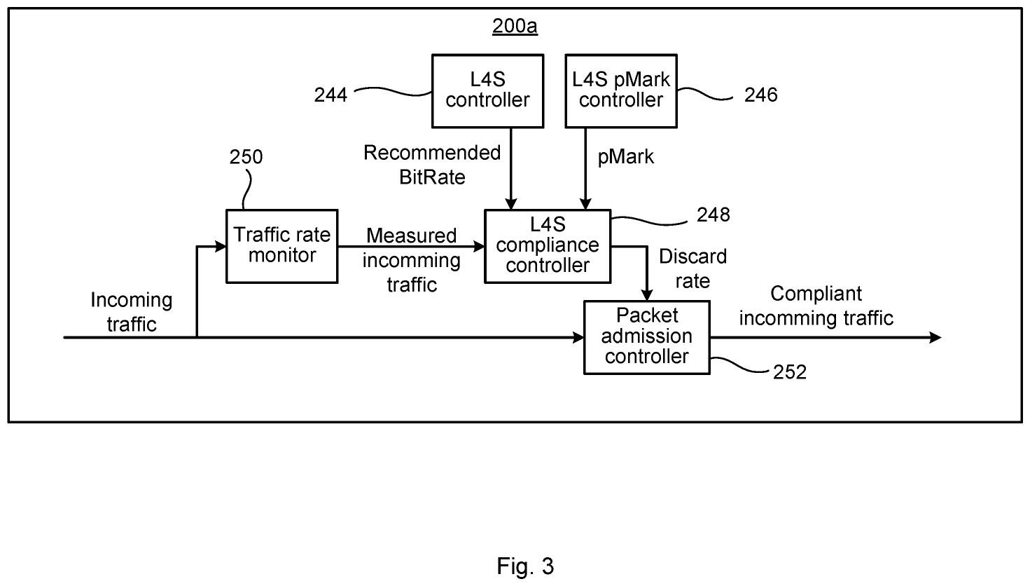

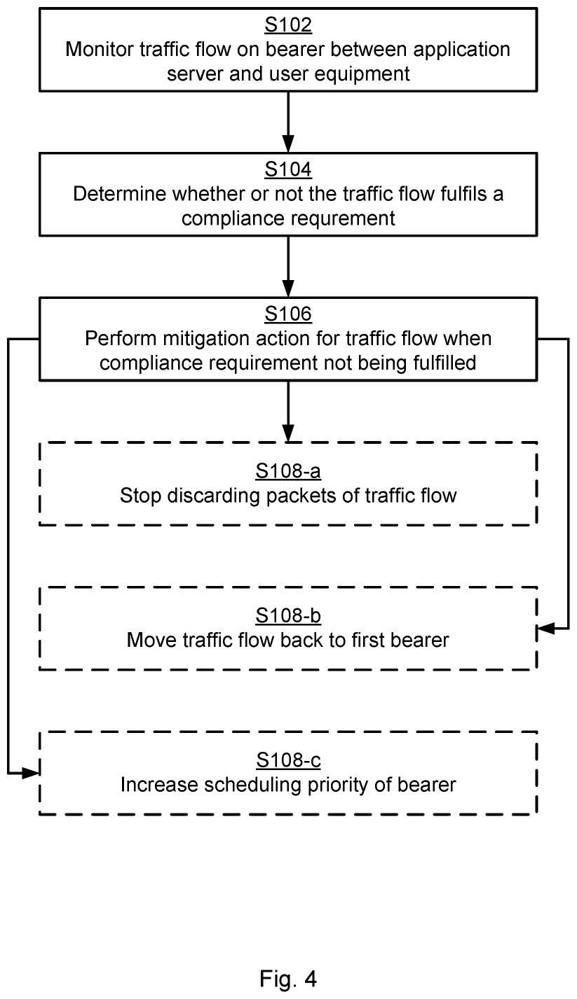

In general terms, the above issues are addressed by providing techniques for protecting a wireless communication system against non-compliant traffic flows. To further illustrate this, a high-level block diagram of a wireless communication network comprising a network node 200a configured to reduce congestion and thereby achieve low-latency is illustrated in FIG. 2. In FIG. 2 is illustrated two bearers being established between an application server 170 and user equipment 150a. 150b. The two bearers are for two traffic flow-types: the bearer for user equipment 150a is for an L4S traffic flow and the bearer for user equipment 150b is for a non-L4S traffic flow, such as an MBB traffic flow. Without loss of generality, to achieve a consistent and low latency for the L4S traffic flow, the L4S traffic flow has a higher priority in the scheduler 240 than the non-L4S traffic flow. However, also other scheduler mechanism can be used to ensure this. The bearers can be used either for an uplink traffic flow or for a downlink traffic flow. In the context of FIG. 2, it is without loss of generality assumed that the bearers are used for a downlink traffic flow. In more detail, network node 200a is in FIG. 2 illustrated to obtain two incoming traffic flows 180a. 180b from the application server 170, where traffic flow 180a represents an L4S traffic flow and traffic flow 180b represents non-L4S traffic flow. Before reaching the scheduler 240, which provides two corresponding outgoing traffic flows 190a. 190b towards the user equipment 150a. 150b in the access network 110, the incoming traffic flows 180a. 180b are processed by a respective Packet Data Convergence Protocol (PDCP) block 242a. 242b. An L4S controller 244 is configured to determine whether incoming packets in the incoming traffic flow 180a are to be marked as congested or not. The decision is based on monitoring the behavior of the scheduler 240 as well as the output from the PDCP block 242a. If a packet is marked as congested, this will lead to a reduction of the throughput of this traffic flow from the application server 170. This is done once the packet has been acknowledged by the application server 170 which sent it (e.g., once the packet has been received by the user equipment 150a, and whose acknowledgement has been sent back to the application server 170). The reason for the reduction in throughput is because the congestion marking signals a congestion event, which will cause the application server 170 to lower its throughput. A compliance controller 248 is configured to monitor whether or not the traffic flow fulfils a compliance requirement and to take the appropriate action when the traffic flow fails to fulfil the compliance requirement. Further details of the functionality of the compliance controller 248 will be disclosed next with reference to FIG. 3 as well as with reference to FIG. 4.

A block diagram of a network node 200a illustrating how compliance controller 248 is configured to monitor whether or not the traffic flow fulfils a compliance requirement is shown in FIG. 3. An L4S controller 244 is configured to monitor incoming channel quality information (CQI) values along with what the dedicated radio resource-share for the L4S traffic is. Based on this, the L4S controller 244 computes a recommended bitrate, which corresponds to the estimated traffic rate which the L4S traffic flow should get in the scheduler 240 in FIG. 2. An L4S compliance controller 248 is configured to monitor whether or not the traffic flow fulfils a compliance requirement and to take the appropriate action when the traffic flow fails to fulfil the compliance requirement. In order to determine whether or not the traffic flow fulfils the compliance requirement, the L4S compliance controller 248 receives an estimate of the actual traffic rate of the incoming traffic, as provided by a traffic rate monitor 250, as well as the recommended bitrate provided from the L4S controller 244 and the congestion markings (denoted pMark) provided by an L4S pMark controller 246. If needed, the L4S compliance controller 248 instructs a packet admission controller 252 to discard some of the packets of the incoming packets, or to perform another mitigating action, thus providing compliant incoming traffic as input to the PDCP block 242a and/or the scheduler 240, depending on the type of mitigating action performed.

As disclosed above, one mechanism by which the L4S-controller 244 detects congestion is by running a virtual queue. This virtual queue takes as input the incoming traffic rate of a given traffic flow, and provides as output a recommended bitrate for the given traffic flow. The recommended bitrate is a function of the radio conditions of the user of the given traffic flow, the percentage of radio-resources the given traffic flow should be allowed to use, and the total number of users for the given traffic flow in the system. The virtual queue-size is updated every time a new packet arrives, according to the following pseudo-code:

tNow=getTime( ); # get current time
vQueue=vQueue−recommendedBitRate·(tNow−tLastUpdate): # estimate how much queue-size has reduced
vQueue=max(0, vQueue): # ensure that queue-size is not negative
vQueue=vQueue+sizeOfNewPacket: # calculate new queue-size
tLastUpdate=tNow: # store time value for latest update

Hence, each time a new packet is entered into the queue it is estimated how much of the queue has disappeared since the last packet was entered (i.e., how much the queue-size has reduced), it is ensured that the queue-size is not negative, and the queue-size is incremented according to the newly received packet.

Based on the updated virtual queue-size, the queue-delay for the incoming packets can be updated according to the following pseudo-code:

vDelay=vQueue/recommendedBitRate; # virtual delay is ratio of queue-size and recommended bitrate

Finally, the L4S pMark controller 246 determines whether the incoming packet should be marked as congested or not. It does so based on the virtual delay and two thresholds; a Lower congestion threshold (Th_L), and an upper congestion threshold (Th_H). In some aspects, the thresholds are regarded the upper and lower latency bounds for the L4S traffic flows. As an example, all packets will be marked as congested if the virtual latency is above Th_H, and no packets will be marked as congested if the virtual latency is below Th_L. The values of these parameters might be specified when setting up the system. In some examples, packets are marked as congested according to the following criterion:

$$p M a r k ( t ) = {[ \frac{v D e l a y ( t ) - T {h}_{L}}{T {h}_{H} - T {h}_{L}} ]}_{0}^{1}$$

In other words, pMark(t) is a ramp between 0 and 1, where the ramp grows linearly as the virtual delay, vDelay(t), grows from Th_L to Th_H. Therefore, no packets are marked as congested when vDelay<Th_L, and all packets are marked as congested when vDelay>Th_H. When Th_L<vDelay<Th_H, the proportion of packets marked as congested follows the value of pMark(t). That is, if pMark(t)=x, where 0<x<1, then there is a probability of x that a packet will be marked as congested.

Since it is assumed that the incoming bitrate is lowered once packets are started to be marked as congested, a potential issue might occur whenever a client application (e.g., as run in the application server 170 for a downlink traffic flow or in the user equipment 150a for an uplink traffic flow) fails to lower the incoming bitrate, lowers the incoming bitrate at too slow a rate, or only after some delay. In such situation, when the traffic flow is not impacted by the congestion marking of the packets, the traffic flow can be classified as non-compliant. As an example, the marking of packets as congested can be regarded as allowing for a certain amount of slack for the traffic flow. For instance, if no packets are marked as congested, the traffic flow is well below its recommended bitrate, and probably has been so for quite some time. In such a case, the traffic flow can be allowed to have a small burst of high bit rate without any packets being marked as congested. In this case it is very clear that the traffic flow is compliant. However, should the packets instead be marked as congested for a prolonged amount of time, it might be concluded that the traffic flow has not been impacted by the congestion markings, and the traffic flow should therefore be considered as non-compliant. Other examples of when a traffic flow fails to fulfil a compliance requirement and therefore is classified as non-compliant will be provided below.

Whenever there are non-compliant traffic flows in the in a wireless communication system, an appropriate action should therefore be performed to ensure that these traffic flows do not consume more radio resources than reasonable.

The embodiments disclosed herein in particular relate to mechanisms for handling a traffic flow 180a, 190a in a wireless communication system 100. In order to obtain such mechanisms there is provided a controller 200a, 200b, a method performed by the controller 200a, 200b, a computer program product comprising code, for example in the form of a computer program, that when run on a controller 200a, 200b, causes the controller 200a, 200b to perform the method.

FIG. 4 is a flowchart illustrating embodiments of methods for handling a traffic flow 180a, 190a in a wireless communication system 100. The methods are performed by the controller 200a, 200b. The methods are advantageously provided as computer programs 720. In essence, the controller 200a, 200b is configured to perform a mitigating action whenever a traffic flow 180a, 190a fails to fulfil a compliance requirement.

S102: The controller 200a, 200b monitors a traffic flow 180a, 190a on a bearer between an application server 170 and a user equipment 150a in the wireless communication system 100. The traffic flow 180a, 190a might be an uplink traffic flow or a downlink traffic flow. The traffic flow 180a, 190a might be scheduled by a scheduler 240 or similar network entity.

S104: The controller 200a, 200b determines whether or not the traffic flow 180a, 190a fulfils a compliance requirement. The compliance requirement pertains to a recommended bitrate being maintained for the traffic flow 180a, 190a. Further aspects of the compliance requirement will be disclosed below.

S106: The controller 200a, 200b performs a mitigating action for the traffic flow 180a, 190a when the traffic flow: 180a, 190a fails to fulfil the compliance requirement. Examples of when the traffic flow 180a, 190a fails to fulfil the compliance requirement will be disclosed below. Examples of mitigating actions will be disclosed below.

This method resolves the above-mentioned issues by introducing a controller 200a, 200b that checks whether or not the traffic flow 180a, 190a fulfils a compliance requirement, and that performs a mitigating action for the traffic flow 180a, 190a when the traffic flow 180a, 190a fails to fulfil the compliance requirement. This enables adaptive compliance control of resource-based traffic flows in a wireless communication system 100.

Embodiments relating to further details of handling a traffic flow 180a, 190a in a wireless communication system 100 as performed by the controller 200a, 200b will now be disclosed.

There might be different types of traffic flows. As in the example of FIG. 2, in some embodiments the traffic flow 180a, 190a is an L4S traffic flow.

Aspects of the recommended bitrate will be disclosed next.

In some aspects, the recommended bitrate corresponds to the estimated traffic rate of the outgoing traffic flow: 180a, 190a from the scheduler 240. That is, in some embodiments, the recommended bitrate pertains to an estimated traffic rate of the traffic flow 180a, 190a output by the scheduler 240.

There could be different ways to determine the recommended bitrate. In some aspects, the recommended bitrate (corresponding to the estimated traffic rate of the outgoing traffic flow 190a) is estimated based on parameter values (and thus artificially recreated). According to some non-limiting examples, the estimated traffic rate output by the scheduler 240 is a function of at least one of: power headroom reports, channel quality information reports, channel quality information (CQI) reports, radio conditions of the user equipment 150a to, or from, which the L4S traffic flow 180a, 190a is to be scheduled, the number user equipment 150a to, or from, which the L4S traffic flow 180a, 190a is to be scheduled, the total share of radio resources available to be scheduled for the user equipment 150a to, or from, which the L4S traffic flow: 180a, 190a is to be scheduled.

Aspects of how it can be determined that the traffic flow 180a, 190a fails to fulfil the compliance requirement will be disclosed next.

In some aspects, whether or not the traffic flow 180a. 190a fails to fulfil the compliance requirement is determined based on observing if there are any packets marked as congested. In particular, in some embodiments, the traffic flow 180a, 190a fails to fulfil the compliance requirement when the packets are marked as congested during at least a predetermined amount of time. There could be different definitions of how long the predetermined amount of time is. In some examples, the predetermined amount of time is defined as a function of some system states. These could for instance be a system constant, where for example if the packets are marked as congested for more than y seconds, the traffic flow will be considered as non-compliant and thus to fail to fulfil the compliance requirement. In this respect, where there are packets marked as congested, this is an indication that the bitrate by which the packets are sent should be lowered. That is, in some examples, the packets marked as congested provide an indication to lower the bitrate of the traffic flow 180a. 190a. The packets should be marked as congested when the virtual delay is too long. That is, in some examples, the packets are marked as congested when a virtual delay of a virtual queue system for the packets is larger than a lower congestion threshold value. In general terms, the virtual queue system is configured to represent a real queue system of the scheduler 240 by estimating the virtual delay for the packets. The virtual delay might be estimated by measuring the traffic flow: 180a, 190a as input to the scheduler 240 and estimating the traffic flow 180a. 190a as output from the scheduler 240.

In some aspects, whether or not the traffic flow 180a. 190a fails to fulfil the compliance requirement is determined based on observing the actual bitrate of the traffic flow 180a, 190a. In particular, in some embodiments, the traffic flow 180a, 190a fails to fulfil the compliance requirement when the traffic flow 180a. 190a is at least a predetermined factor higher than the recommended bitrate for the traffic flow 180a, 190a during at least a predetermined amount of time.

It is also possible to combine the information of congested packets with the recommended bitrate (in the pseudo-code denoted “recommendedBitRate”) and incoming bitrate information (in the pseudo-code denoted “incomingBitRate”). This can be expressed according to the following pseudo-code:

IF (pMark==1 and incomingBitRate>beta·recommendedBitRate) then the traffic flow is determined to be non-compliant.

Here beta is a value>1 used to find a scaling of the recommendedBitRate which can be perceived as tolerable. The sequence of values of incomingBitRate might first be low-pass filtered to filter out any high frequency transients and thus ensure that only the long-term trends for the traffic flow are considered.

In some aspects, whether or not the traffic flow 180a, 190a fails to fulfil the compliance requirement is determined based on observing the radio resource usage of the traffic flow 180a. 190a. In particular, in some embodiments, the traffic flow 180a. 190a occupies radio resources, and wherein the traffic flow 180a. 190a fails to fulfil the compliance requirement when the traffic flow occupies more than a predetermined amount of the radio resources during at least a predetermined amount of time. One motivation for this is that when there are comparatively many users of the traffic flow 180a, 190a it becomes critical that none of these users uses more than its fair share of the available radio resources. Hence, also the radio resource usage of the traffic flow 180a, 190a might be considered when determining whether or not the traffic flow 180a, 190a fails to fulfil the compliance requirement. In the opposite case, when there are comparatively few users of the traffic flow 180a. 190a it becomes less critical that none of these user uses more than its fair share of the available radio resources This could be manifested in the value of the predetermined amount of time. This could also be manifested in the value of beta, so that more spare capacity, in terms of available radio resources, for the users implies a larger value of beta and larger value of the predetermined amount of time, and vice versa for less spare capacity.

Quality of service might be considered instead of amount of radio resources. Therefore, in some aspects, whether or not the traffic flow 180a, 190a fails to fulfil the compliance requirement is determined based on observing the quality of service of the traffic flow 180a, 190a. In particular, in some embodiments, the traffic flow: 180a, 190a is associated with a quality of service value, and the traffic flow 180a, 190a fails to fulfil the compliance requirement when the quality of service value of the traffic flow occupies is higher than a predetermined quality value during at least a predetermined amount of time. In some examples, the quality of service value is a value corresponding to an amount of radio resources which depends on the radio link quality.

In general terms, one objective of the mitigation is to enforce the recommended bitrate. Therefore, in some embodiments, the mitigating action operates to enforce the recommended bitrate for the traffic flow 180a, 190a

Aspects of different types of mitigating actions that can be performed will be disclosed next.

A first mitigating action pertains to discarding some of the incoming packets of the non-compliant traffic flow such that the incoming bitrate (after discarding) is not higher than the recommended bitrate. That is, in some embodiments, the mitigating action comprises discarding some of the packets of the traffic flow 180a. 190a. In the block diagram if FIG. 2, this is schematically illustrated at (a).

A second mitigating action pertains to at least temporarily move the non-compliant traffic flow from a high-priority bearer to a low-priority bearer. That is, in some embodiments, the bearer is a first bearer having a first scheduling priority in the scheduler 240, and the mitigating action comprises moving the traffic flow 180a, 190a to a second bearer having a second scheduling priority in the scheduler 240 being lower than the first scheduling priority. In the block diagram if FIG. 2, this is schematically illustrated at (b).

A third mitigating action pertains to at least temporarily adjusting the scheduling priority of the non-compliant traffic flow such that this traffic flow at least temporarily has a lower scheduling priority (e.g., a priority equal to the priority for MBB traffic). That is, in some embodiments, the bearer has a scheduling priority in the scheduler 240, and the mitigating action comprises lowering the scheduling priority. In the block diagram if FIG. 2, this is schematically illustrated at (c).

Further details of each of these mitigating actions will be disclosed next.

Further details of the first mitigating action to discard some of the incoming packets of the non-compliant traffic flow will now be disclosed.

By discarding some of the packets of the traffic flow 180a, 190a, the scheduling priority of any non-compliant traffic flow 180a, 190a can be kept unaltered. Likewise, the non-compliant traffic flow 180a, 190a does not need to be moved to another bearer.

The discarding might be at a rate such that the remaining packets enter the system at a rate equal to the recommended bitrate. By discarding packets at this rate, it will be ensured that the congestion markings are not affected, since the incoming bitrate is still equal to the recommended bitrate. Yet, it will still be ensured that the non-compliant traffic flow 180a, 190a does not consume any more radio resources than allocated. This can be expressed according to the following pseudo-code:

```
inRate = estimateInRate( ); # read value from the traffic rate monitor
if (pMark == 1)
  tNow = getTime( );
  discRate = max(0,inRate − recommendedBitRate); # compute
  discard rate
  discardPackets(discRate · (tNow − tOld)); # discard some of the
  packets
  tOld = tNow;
}
```

The discarding of packets can be stopped once the traffic flow 180a, 190a is compliant again. Hence, in some embodiments, the controller 200a, 200b is configured (optional) step S108-a:

S108-a: The controller 200a, 200b stops discarding the packets of the traffic flow 180a, 190a when the traffic flow 180a, 190a fulfils the compliance requirement.

Further details of the second mitigating action to at least temporarily move the non-compliant traffic flow from a high-priority bearer to a low-priority bearer will now be disclosed.

In some aspects, the low-priority bearer has the same priority as a bearer dedicated for MBB traffic. That is, in some embodiments, the second bearer has same scheduling priority in the scheduler 240 as an MBB traffic flow: 180b, 190b.

In this way, it might not be necessary to discard any packets of the non-compliant traffic flow to ensure that it becomes compliant. Instead, the non-compliant traffic flow has to compete for radio resources on the same conditions as other traffic flows.

Once the non-compliant traffic flow has been moved to the low-priority bearer, a virtual queue might still be maintained and the recommended bitrate might still be utilized to decide whether packets should be marked as congested or not, just as when the traffic flow was on the high-priority bearer. Should the non-compliant traffic flow begin to react to the congestion markings and have its bitrate lowered such that not all packets are marked as congested, the traffic flow will be assumed to be compliant again. The same applies for the remaining above disclosed alternatives for determined that the traffic flow 180a, 190a fails to fulfil the compliance requirement. That is, the traffic flow 180a, 190a might be moved back to a high-priority bearer once the traffic flow 180a, 190a is compliant again. Hence, in some embodiments, the controller 200a, 200b is configured (optional) step S108-b:

S108-b: The controller 200a, 200b moves the traffic flow 180a, 190a back to the first bearer when the traffic flow 180a, 190a fulfils the compliance requirement.

The first mitigating action can be combined with the second mitigating action. In this way some packets are discarded at the same time as the traffic flow 180a, 190a is moved to another bearer (with lower scheduling priority).

Further details of the third mitigating action to at least temporarily adjusting the scheduling priority of the non-compliant traffic flow will now be disclosed.

By at least temporarily adjusting the scheduling priority of the non-compliant traffic flow it might neither required to discard some of the packets nor to move the entire traffic flow to a low-priority bearer.

Once the priority of the bearer for the non-compliant traffic flow has been lowered, a virtual queue might still be maintained and the recommended bitrate might still be utilized to decide whether packets should be marked as congested or not. Should the non-compliant traffic flow begin to react to the congestion markings and have its bitrate lowered such that not all packets are marked as congested, the traffic flow will be assumed to be compliant again. The same applies for the remaining above disclosed alternatives for determined that the traffic flow 180a, 190a fails to fulfil the compliance requirement. That is, the scheduling priority might be increased once the traffic flow 180a, 190a is compliant again. Hence, in some embodiments, the controller 200a, 200b is configured (optional) step S108-c:

S108-c: The controller 200a, 200b increases the scheduling priority of the bearer when the traffic flow 180a. 190a fulfils the compliance requirement.

The first mitigating action can be combined with the third mitigating action. In this way some packets are discarded at the same time as the scheduling priority of the traffic flow 180a. 190a is lowered.

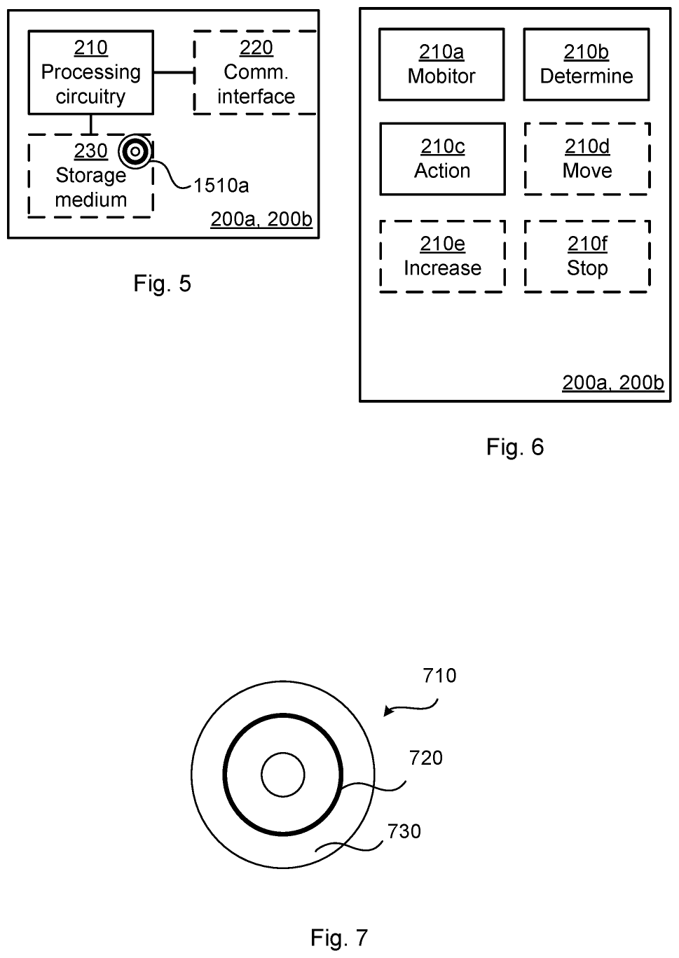

FIG. 5 schematically illustrates, in terms of a number of functional units, the components of a controller 200a. 200b according to an embodiment. Processing circuitry 210 is provided using any combination of one or more of a suitable central processing unit (CPU), multiprocessor, microcontroller, digital signal processor (DSP), etc., capable of executing software instructions stored in a computer program product 710 (as in FIG. 7), e.g. in the form of a storage medium 230. The processing circuitry 210 may further be provided as at least one application specific integrated circuit (ASIC), or field programmable gate array (FPGA).

Particularly, the processing circuitry 210 is configured to cause the controller 200a. 200b to perform a set of operations, or steps, as disclosed above. For example, the storage medium 230 may store the set of operations, and the processing circuitry 210 may be configured to retrieve the set of operations from the storage medium 230 to cause the controller 200a, 200b to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The controller 200a. 200b may further comprise a communications interface 220 at least configured for communications with other entities, functions, nodes, and devices. As such the communications interface 220 may comprise one or more transmitters and receivers, comprising analogue and digital components. The processing circuitry 210 controls the general operation of the controller 200a. 200b e.g. by sending data and control signals to the communications interface 220 and the storage medium 230, by receiving data and reports from the communications interface 220, and by retrieving data and instructions from the storage medium 230. Other components, as well as the related functionality, of the controller 200a, 200b are omitted in order not to obscure the concepts presented herein.

FIG. 6 schematically illustrates, in terms of a number of functional modules, the components of a controller 200a. 200b according to an embodiment. The controller 200a, 200b of FIG. 6 comprises a number of functional modules: a monitor module 210a configured to perform step S102, a determine module 210b configured to perform step S104, and an action module 210c configured to perform step S106. The controller 200a. 200b of FIG. 6 may further comprise a number of optional functional modules, such as any of a move module 210d configured to perform step S108-a, an increase module 210c configured to perform step S108-b, and a stop module 210f configured to perform step S108-c. In general terms, each functional module 210a:210f may in one embodiment be implemented only in hardware and in another embodiment with the help of software. i.e., the latter embodiment having computer program instructions stored on the storage medium 230 which when run on the processing circuitry makes the controller 200a. 200b perform the corresponding steps mentioned above in conjunction with FIG. 6. It should also be mentioned that even though the modules correspond to parts of a computer program, they do not need to be separate modules therein, but the way in which they are implemented in software is dependent on the programming language used. Preferably, one or more or all functional modules 210a: 210f may be implemented by the processing circuitry 210, possibly in cooperation with the communications interface 220 and/or the storage medium 230. The processing circuitry 210 may thus be configured to from the storage medium 230 fetch instructions as provided by a functional module 210a: 210f and to execute these instructions, thereby performing any steps as disclosed herein.

The controller 200a. 200b may be provided as a standalone device or as a part of at least one further device. For example, controller 200a may be provided in a node of the radio access network or in a node of the core network. Alternatively, functionality of the controller 200a may be distributed between at least two devices, or nodes. These at least two nodes, or devices, may either be part of the same network part (such as the radio access network or the core network) or may be spread between at least two such network parts. For example, controller 200b may be provided at least in a user equipment 200b. Thus, a first portion of the instructions performed by the controller 200a. 200b may be executed in a first device, and a second portion of the of the instructions performed by the controller 200a. 200b may be executed in a second device: the herein disclosed embodiments are not limited to any particular number of devices on which the instructions performed by the controller 200a. 200b may be executed. Hence, the methods according to the herein disclosed embodiments are suitable to be performed by a controller 200a. 200b residing in a cloud computational environment. Therefore, although a single processing circuitry 210 is illustrated in FIG. 5 the processing circuitry 210 may be distributed among a plurality of devices, or nodes. The same applies to the functional modules 210a: 210f of FIG. 6 and the computer program 720 of FIG. 7.

FIG. 7 shows one example of a computer program product 710 comprising computer readable storage medium 730. On this computer readable storage medium 730, a computer program 720 can be stored, which computer program 720 can cause the processing circuitry 210 and thereto operatively coupled entities and devices, such as the communications interface 220 and the storage medium 230, to execute methods according to embodiments described herein. The computer program 720 and/or computer program product 710 may thus provide means for performing any steps as herein disclosed.

In the example of FIG. 7, the computer program product 710 is illustrated as an optical disc, such as a CD (compact disc) or a DVD (digital versatile disc) or a Blu-Ray disc. The computer program product 710 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 720 is here schematically shown as a track on the depicted optical disk, the computer program 720 can be stored in any way which is suitable for the computer program product 710.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for handling a traffic flow in a wireless communication system, the method being performed by a controller, the method comprising:
monitoring a traffic flow on a bearer between an application server and a user equipment in the wireless communication system, the traffic flow being scheduled by a scheduler;
determining whether or not the traffic flow fulfils a compliance requirement, the compliance requirement pertaining to a recommended bitrate being maintained for the traffic flow; and
performing a mitigating action for the traffic flow when the traffic flow fails to fulfil the compliance requirement.

2. The method according to claim 1, wherein the traffic flow is a low-latency, low-loss, scalable throughput, L4S, traffic flow.

3. The method according to claim 1, wherein the recommended bitrate pertains to an estimated traffic rate of the traffic flow output by the scheduler.

4. The method according to claim 2, wherein the estimated traffic rate output by the scheduler is a function of at least one of: power headroom reports, channel quality information reports, radio conditions of the user equipment to, or from, which the LAS traffic flow is to be scheduled, number user equipment to, or from, which the LAS traffic flow is to be scheduled, total share of radio resources available to be scheduled for the user equipment to, or from, which the LAS traffic flow is to be scheduled.

5. The method according to claim 1, wherein the traffic flow fails to fulfil the compliance requirement when the packets are marked as congested during at least a predetermined amount of time.

6. The method according to claim 1, wherein the traffic flow fails to fulfil the compliance requirement when the traffic flow is at least a predetermined factor higher than the recommended bitrate for the traffic flow during at least a predetermined amount of time.

7. The method according to claim 1, wherein the traffic flow occupies radio resources, and wherein the traffic flow fails to fulfil the compliance requirement when the traffic flow occupies more than a predetermined amount of the radio resources during at least a predetermined amount of time.

8. The method according to claim 1, wherein the traffic flow is associated with a quality of service value, and wherein the traffic flow fails to fulfil the compliance requirement when the quality of service value of the traffic flow occupies is higher than a predetermined quality value during at least a predetermined amount of time.

9. The method according to claim 1, wherein the mitigating action operates to enforce the recommended bitrate for the traffic flow.

10. The method according to claim 1, wherein the mitigating action comprises discarding some of the packets of the traffic flow.

11. The method according to claim 10, wherein the method further comprises:
stopping discarding said some of the packets of the traffic flow when the traffic flow fulfils the compliance requirement.

12. The method according to claim 1, wherein the bearer is a first bearer having a first scheduling priority in the scheduler, and wherein the mitigating action comprises moving the traffic flow to a second bearer having a second scheduling priority in the scheduler being lower than the first scheduling priority.

13. The method according to claim 12, wherein the second bearer has same scheduling priority in the scheduler as a mobile broadband, MBB, traffic flow.

14. The method according to claim 12, wherein the method further comprises:
moving the traffic flow back to the first bearer when the traffic flow fulfils the compliance requirement.

15. The method according to claim 1, wherein the bearer has a scheduling priority in the scheduler, and wherein the mitigating action comprises lowering the scheduling priority.

16. The method according to claim 15, wherein the method further comprises:
increasing the scheduling priority of the bearer when the traffic flow fulfils the compliance requirement.

17. A controller for handling a traffic flow in a wireless communication system, the controller comprising processing circuitry, the processing circuitry being configured to cause the controller to:
monitor a traffic flow on a bearer between an application server and a user equipment in the wireless communication system, the traffic flow being scheduled by a scheduler;
determine whether or not the traffic flow fulfils a compliance requirement, the compliance requirement pertaining to a recommended bitrate being maintained for the traffic flow; and
perform a mitigating action for the traffic flow when the traffic flow fails to fulfil the compliance requirement.

18. A controller for handling a traffic flow in a wireless communication system, the controller comprising:
a monitor module configured to monitor a traffic flow on a bearer between an application server and a user equipment in the wireless communication system, the traffic flow being scheduled by a scheduler;
a determine module configured to determine whether or not the traffic flow fulfils a compliance requirement, the compliance requirement pertaining to a recommended bitrate being maintained for the traffic flow; and
an action module configured to perform a mitigating action for the traffic flow when the traffic flow fails to fulfil the compliance requirement.

19. (canceled)

20. A computer program for handling a traffic flow in a wireless communication system, the computer program comprising computer code which, when run on processing circuitry of a controller, causes the controller to:
monitor a traffic flow on a bearer between an application server and a user equipment in the wireless communication system, the traffic flow being scheduled by a scheduler;
determine whether or not the traffic flow fulfils a compliance requirement, the compliance requirement pertaining to a recommended bitrate being maintained for the traffic flow; and
perform a mitigating action for the traffic flow when the traffic flow fails to fulfil the compliance requirement.

21. (canceled)
